(19) United States
(12) Patent Application Publication
(10) Pub. No.: US 2008/0155602 A1
(43) Pub. Date: Jun. 26, 2008

(54) METHOD AND SYSTEM FOR PREFERRED CONTENT IDENTIFICATION

(76) Inventors: Jean-Luc Collet, La Gaude (FR); Francois-Xavier Drouet, La Gaude (FR); Fabien Lanne, Valbonne (FR)

Correspondence Address: HOFFMAN, WARNICK & D'ALESSANDRO LLC, 75 STATE ST, 14 FL, ALBANY, NY, 12207, US

(21) Appl. No.: 11/942,168

(22) Filed: Nov. 19, 2007

(30) Foreign Application Priority Data
Dec. 21, 2006 (EP) 06301282.7

(51) Int. Cl. H04N 5/445

(52) U.S. Cl. 725/46

(57) ABSTRACT

A content stream user defines preferences, which are compared to aggregated metadata describing in real time a plurality of content streams to which the user has access. The metadata for each content stream may be generated by automated analysis of onscreen indicators, noise levels in standard video or audio sequences, or speech recognition or image recognition data applied to identify particular keywords, individuals, etc. Where a match between content and user preferences is identified, the user is notified, and may be given the option of switching to the matching content stream. A number of approaches are used to ensure that the user is able to access the whole of the content of interest, and does not miss the starting porting. Certain parts of the content streams may be cached for video on demand viewing, or the content streams may be buffered allowing access to various portions of the stream, or a delay in content transmission may be introduced relative to the metadata transmission so as to allow time for a content stream change.

### FIELD OF THE INVENTION

The present invention relates to the field of content transmission systems such as radio or television, and the identification at a user device of content of interest to a particular user.

### BACKGROUND OF THE INVENTION

With the advent of technologies such as cable television, satellite television, and more recently digital or packet based media such as video over IP via the internet, telephone network, etc., consumers are faced with an increasingly unmanageable number of possible TV channels. For example, while watching one channel, or even a selected plurality of channels, users have no visibility on what is happening on other channels. Various approaches have been proposed with a view to increasing a user's ability to identify and view all of the transmissions that are of interest to him or her.

U.S. Pat. No. 6,721,954, for example, discloses a method for implementing a preferred viewing of a library of programs. An electronic program guide is searched for a program satisfying user's criteria. If a given program satisfies the criterion then at a predetermined time, it is recorded and organized in a program library so that the user can view the recorded program at a later time.

U.S. Pat. No. 5,512,935 discloses a method and apparatus for alerting a user of a cable television system with an alert notice generated by a service provider of information subscribed by the user. The alerts sent by service provider are not displayed effectively on the television served by the cable television system due to transmission errors. The apparatus comprises a computer, a home controller, an input cable from the cable television system, a modulator, a modem communication link and a set top box. The set top box is connected to the television and determines which the channel to be delivered and the modulator resides inside the home controller. The personal computer and home controller are in turn connected to the set top box and the input cable. The service provider through the modem link transmits the alert message to user's personal computer and if any acknowledgement is not transmitted back to the service provider then a command message is sent to the personal computer instructing it to activate the modulator. The home controller determines the channel being watched by gathering information from the set top box and relays it back to the personal computer. The personal computer then instructs the modulator to tune to the correct channel being viewed providing a greater likelihood of alerting user that an alert has been received.

US 2004/0044677 discloses a method of conveying and classifying content of all kind of data sources in a media system to provide a user with most relevant data content and services available fitting the user's preferences. Content and services provided by media sources is received and standardized. The user behavior related to the selected content is assessed and recorded in a user history log. A behavioral profile is assessed and the available content is evaluated. The end users are provided with a personalized recommendations list of content from various media sources based on the corresponding user history log.

WO 02/43353 A2 discloses a method for determining the desirability of video programming events. The desirability of programming events is determined by analyzing metadata for individual programming events using viewer preferences represented in viewer profiles. Metadata of a video stream includes scores associated with the categories of a classification hierarchy and the viewer profiles include preference scores associated with the categories of classification hierarchy. Keywords in user profiles are also associated with individual categories of classification hierarchy. Analysis of programming events is performed to determine a recording schedule or an alert schedule.

Existing technologies, for example, as described above are dependent on prior knowledge of scheduled transmission being available to all interested parties. It is desirable however to define mechanisms to inform TV viewers in real time about “pre-defined events of interest” happening on other channels or made available in video on demand (VoD).

### SUMMARY OF THE INVENTION

The present invention addresses these and other drawbacks of the prior art, by taking into account the real time content of television channels, beyond what is present in conventional program guides.

According to an aspect of the invention, there is provided a method of informing a user of a first content stream at a first user device of content of a second content stream that may be of interest to the user, comprising: storing content preferences of the user at the first user device; receiving an aggregate metadata stream at the first user device, the aggregate metadata stream comprising data aggregated from a plurality of metadata streams describing respectively an instantaneous content of the content streams responsive to events represented in the content streams; comparing a content of the aggregate metadata stream to the content preferences of the user; and in a case where the content of the aggregate metadata stream is found to indicate that the content of the second content stream corresponds to an aspect of the content preferences of the user, notifying the user.

According to another aspect of the present invention, there is provided a method of informing a user of a first content stream at a first user device of content of a second content stream that may be of interest to the user, comprising: generating respective metadata streams describing an instantaneous content of the content streams responsive to events represented in the content streams; associating each content stream with the respective metadata stream; aggregating the metadata associated with the first and second content streams to form an aggregate metadata stream; transmitting the aggregate metadata stream to the first user device for comparison of a content of the aggregate metadata stream to user content preferences stored at the first user device; and notifying the user in a case where the content of the aggregate metadata stream is found to indicate that the content of the second content stream corresponds to an aspect of the content preferences.

According to another aspect of the present invention, there is provided a program product stored on a computer readable medium, which when executed, informs a user of a first content stream at a first user device of content of a second content stream that may be of interest to the user, the computer readable medium comprising program code for: storing content preferences of the user at the first user device; receiving an aggregate metadata stream at the first user device, the aggregate metadata stream comprising data aggregated from a plurality of metadata streams describing respectively an instantaneous content of the content streams responsive to events represented in the content streams; comparing a content of the aggregate metadata stream to the content preferences of the user; and in a case where the content of the aggregate metadata stream is found to indicate that the content of the second content stream corresponds to an aspect of the content preferences of the user, notifying the user.

According to another aspect of the present invention, there is provided a system for informing a user of a first content stream at a first user device of content of a second content stream that may be of interest to the user, comprising: a system for storing preferences of the user at the first user device content; a system for receiving an aggregate metadata stream at the first user device, the aggregate metadata stream comprising data aggregated from a plurality of metadata streams describing respectively an instantaneous content of the content streams responsive to events represented in the content streams; a system for comparing a content of the aggregate metadata stream to the content preferences of the user; and a system for notifying the user in a case where the content of the aggregate metadata stream is found to indicate that the content of the second content stream corresponds to an aspect of the content preferences of the user.

### BRIEF DESCRIPTION OF THE DRAWINGS

Embodiments of the present invention will now be described by way of example with reference to the accompanying drawings, in which like references denote similar elements.

FIG. 1 shows a system for the transmission of digital content streams of an IP network.

FIG. 2 shows an embodiment in accordance with the present invention.

FIG. 3 shows the embodiment of FIG. 2 in the form of a flow chart.

FIG. 4 shows another embodiment in accordance with the present invention.

FIG. 5 shows the embodiment of FIG. 4 in the form of a flow chart.

FIG. 6 illustrates another embodiment in accordance with the present invention.

FIG. 7 illustrates another embodiment in accordance with the present invention.

### DETAILED DESCRIPTION OF THE INVENTION

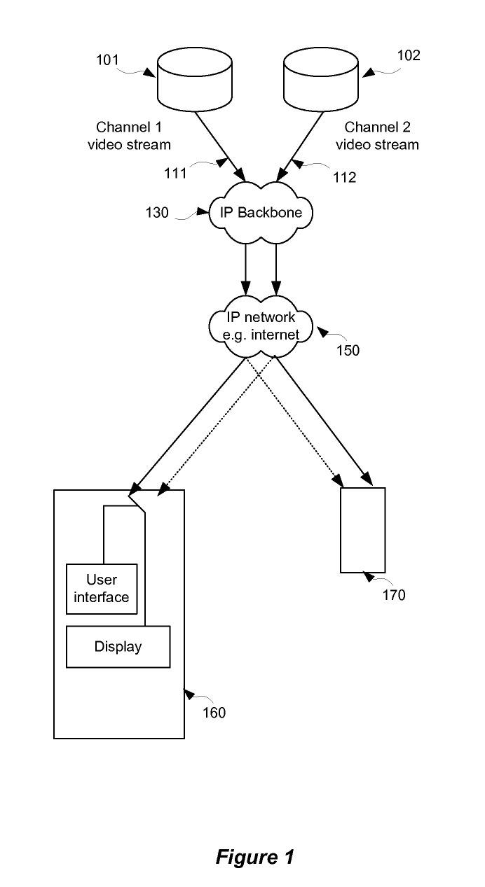

FIG. 1 shows a system for the transmission of digital content streams of an IP network. The system comprises data sources 101 and 102, each of which stores and outputs a respective digital content stream 111 and 112. Each of these content streams corresponds to a television channel. The content streams are transmitted over an IP backbone 130, and then an IP network such as the internet 150 to a number of user devices 160, 170. These user devices are capable of requesting that a particular content stream be sent to them via the IP network 150, by means of a signal transmitted over that same IP network, and of receiving and decoding the resulting content stream for presentation to a user on a display 163 integrated in the user device. The user is able to prompt the user device to request a particular content stream by means of a user interface 164 integrated in the user device.

Existing technologies, for example, as described above, are dependent on prior knowledge of scheduled transmission being available to all interested parties. The present invention, however, provides mechanisms to inform TV viewers in real time about “pre-defined events of interest” happening on other channels or made available in VoD. Examples of pre-defined events per channel type include:

News channels: be informed of breaking news while watching a movie;

Sports channels: be informed of goals in a match while watching a movie or another match on a different channel, be informed of world record breaks, etc.; Movies: be informed that a movie with actor/actress XYZ is starting; and Thematic: be informed that a program about scuba diving is starting.

Mechanisms are provided to allow users to control their TV experience, for example:

Ignore the information;

Move to a different TV experience;

Switch to a different channel; or

Engage in a VoD session if the “pre-defined” event requires it in nature (goals and breaking news are available on demand for example).

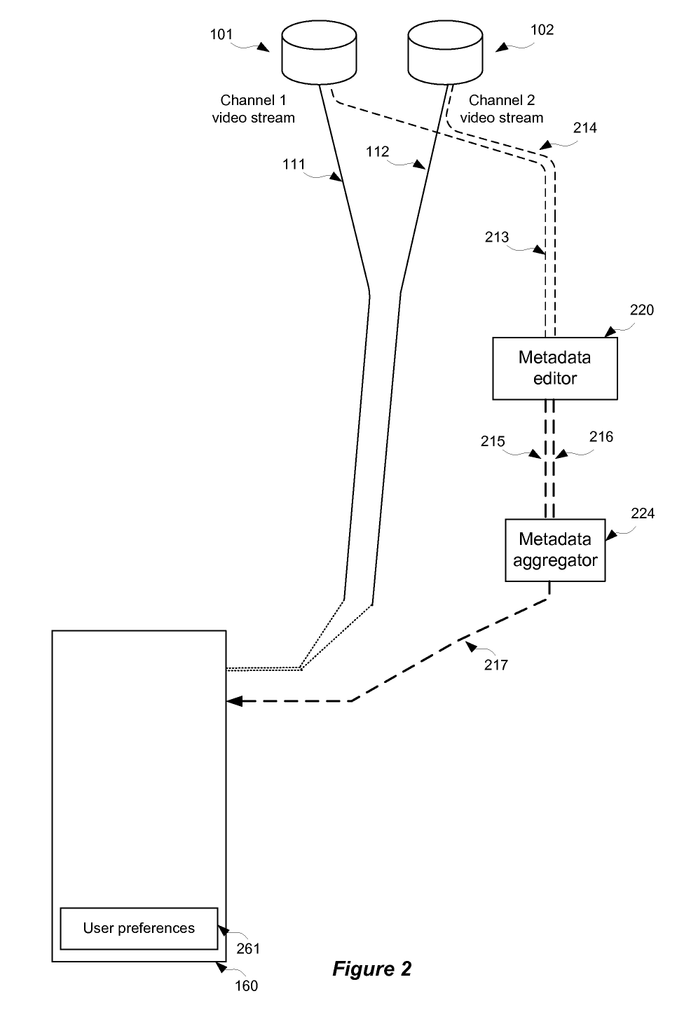

FIG. 2 shows an embodiment in accordance with the present invention. According to this embodiment, a user device as described above may be adapted to receive a number of content streams. It may be imagined that the content provider managing data sources 101 and 102 may provide basic metadata describing the content of the content streams 111, 112. For example, the content provided might define metadata describing the content in terms of the program type (sports, news, current affairs, drama, etc.), the recommended audience age, technical requirements for decoding, names of individuals involved in the program, topics addressed therein, etc. Typically, such metadata will have a high level of granularity, and will relate to a program as a whole.

The user defines viewing preferences 261, which are stored in the user device 160. The viewing preferences 261 can be defined in terms corresponding to those used in the metadata used to describe the content stream subject matter. The viewing preferences 261 may be defined directly by user interaction with the user device 160, or by means of an alternative interface such as a desktop computer or similar. The viewing preferences 261 may be transferred to the user device 160 by any suitable means, such a Ethernet, WiFi, Bluetooth, or the internet.

Basic metadata 213, 214 is further processed at a metadata editor 220 responsive to events represented in the content stream 111, 112 so as to enrich the metadata 213, 214, thereby forming enhanced metadata 215, 216. Specifically, the content of the basic metadata 213, 214 is enriched so as describe substantially in real time and at an improved level of detail the content of the content stream 111, 112. For example, in the case where the content stream 111, 112 corresponds to a news emission, the enhanced metadata 215, 216 might indicate the issue being presented at a given moment, or in a sports emission the enhanced metadata 215, 216 may indicate moments of particular interest, for example, when a particular team has an advantage, a goal is scored, etc. It will be appreciated that this enhanced metadata 215, 216 is qualitatively different than the basic metadata 213, 214, in that while the basic metadata 213, 214 may be derived simply from programming schedules, without knowledge of the actual content of the content stream 111, 112 at any particular moment, while the enhanced metadata 215, 216 is dependent on an analysis of the content stream 111, 112 itself. The metadata editor 220 can carry out an automated analysis of each content stream 111, 112 so as to detect particular events represented therein. There are a wide variety of factors from which such analysis may draw useful conclusions: some regions use onscreen indicators that the end of a transmission is approaching. Rising noise levels in sporting events may indicate particularly exciting or intense activity, particular standard video or audio sequences may indicate for example the beginning of a film or a weather forecast. Speech recognition and/or image recognition technologies may be applied to identify particular keywords, individuals, etc. Naturally, information thus gathered will be interpreted in the light of information already available in the basic metadata 213, 214. All of the above and other factors may be used to draw conclusions allowing the enrichment of the basic metadata 213, 214 entirely automatically. Alternatively, the basic metadata 213, 214 may be enriched with input from a human viewer, either entirely independently or with the benefit of hints from an automatic analysis as described above. There are also events that may be detected by a human being that will be integrated into the video breaking news grabber and after being encoded with the right syntax will be broadcast to video breaking news client. This is typically for contextual events happening in a program, such as goals or red cards for a football match, breaking news for a news channel, etc.

The enhanced metadata 215, 216 streams are next aggregated at a metadata aggregator 224, to form an aggregated metadata stream 217. The aggregated metadata stream 217 comprises information concerning a plurality of content streams. The metadata aggregator 224 may simply aggregate metadata concerning all available content streams, or may aggregate metadata streams concerning only a particular category of content streams. For example, there may be provided a database containing details of content streams of interest to a particular user, or content streams to which a particular user or class of users has subscribed, or content streams that are decidable on a particular class of user devices. The aggregated metadata stream 217 may be compressed, and may be encrypted as required. The metadata preferably takes the form of XML formatted data. The aggregated metadata preferably describes in a synchronous manner the subject matter of each content stream in question. This may involve notionally splitting the content stream into periods of a predetermined length, for example, a second, or length of the period may be dynamically determined as a function of the nature of the content and its volatility. In this case, each time segment might be associated with a corresponding piece of metadata. Alternatively each piece of information may be associated with a particular time value, with no data being transmitted for some time values, the assumption being that its information content remains valid until a new value is transmitted. Alternatively, the information in the content stream may be broken down by reference to digital subdivisions such as packets, frames, intra coding pictures as using for example in the mpeg 2 standard etc. In this case, each digital subdivision might be associated with a corresponding piece of metadata. Alternatively each piece of information may be associated with particular digital subdivisions, with no data being transmitted for some such digital subdivisions, the assumption being that its information content remains valid until a new value is transmitted. Still further approached may be envisaged, corresponding to TV screen scans, film frames, etc. It will be appreciated that while some or all of the metadata streams aggregated by the metadata aggregator 224 may be enriched as described above, it is not required that all such streams are thus enriched, or indeed that any of them are so enriched. Preferably, at least one metadata stream is enriched as described above.

The aggregated metadata stream 217 is then transmitted to the user device 160, and can be broadcast or multicast to a number of other user devices. For example, where the aggregated metadata comprises metadata concerning a class of channels associated with a particular set of user devices or users, that aggregated metadata can be made available to all devices in that set.

The aggregated metadata stream 217 may be integrated into whatever content stream each user device is presently receiving, or may form an entirely separate transmission. Where the metadata and content streams are transmitted separately, it may be desirable to control the transmission times of the two streams through the IP network 150 so that the two streams remain in synchrony. Alternatively, the user device 160 may be provided with buffer means for each stream so that even if the two streams arrive out of synchrony, they may be resynchronized locally. In any case, where a user is not at present using any content stream, the aggregated metadata stream 217 may be transmitted regardless, so that the user may be alerted to content of interest.

On arrival at the user device 160 the aggregated metadata stream 217 will be decoded as necessary, and compared to the user preferences 261 stored at that user device 160. It will be determined whether or not the aggregated metadata indicates that one of the content streams includes content which is of interest to the user. The system will disregard metadata concerning a content stream that the user is already accessing, since the user is presumably already aware of it's content.

In a case where it is determined that the aggregated metadata does indicate that one of the content streams includes content which is of interest to the user, assuming that the user is not already accessing the content stream in question, the system will notify the user of the content of interest. The system may offer the user an option of switching to the content of interest, bypassing the usual channel selection interface. The system may select the channel of interest for parallel access, so as, for example, to display both video channels, for example, by means of a picture in picture display. The system may still further simply automatically select the content of interest for immediate display in place of the present content, or indeed where no content is presently being accessed, without further user interaction. The system may further automatically revert to the original content, or automatically offer the option of reverting to the original content, etc., once it is detected the newly selected content stream no longer corresponds to the users preferences. For example, the system may be set up so as to interrupt any program to shown goals scored in football matches concerning certain teams, but to revert immediately to the original channel once the action is over. All of these options defining the behavior of the system may be defined in the user preferences 261 in addition to subject matter preferences, and may be accessed and modified by any suitable method as discussed with respect to the user's subject matter preferences.

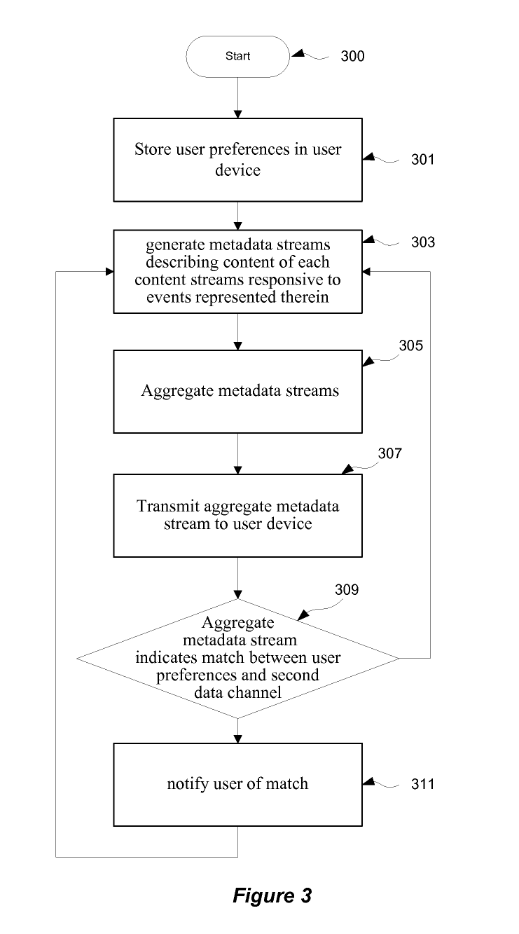

FIG. 3 shows the embodiment of FIG. 2 in the form of a flow chart. The embodiment described above with respect to the system shown in FIG. 2 may be envisaged correspondingly as a method as shown in FIG. 3. Specifically, as described above, there may be envisaged a method of informing a user of a first content stream at a first user device of content of a second content stream that may be of interest to that user. The method comprises: storing at the first user device content preferences of the user (301); generating respective metadata streams describing the instantaneous content of the content streams responsive to events represented in the content streams (302) and associating each the content stream with the respective metadata stream (303); aggregating the metadata associated with the first and second content streams to form an aggregate metadata stream (305); transmitting the aggregate metadata stream to the first user device (307); comparing the content of the aggregate metadata stream to the preferences (309); and in a case where the content of the aggregate metadata stream is found to indicate that the content of the second content stream corresponds an aspect of the content preferences, notifying the viewer (311).

In order to deliver the full context to the end user who is willing to interrupt his current linear programming experience to switch to the experience suggested by the event, it may be desirable that as part of the news and metadata editing process a process of recording content and pushing content to VoD servers is included. For example, the news and metadata editor once it has detected a goal, manages to extract the 2 mns video and pushes this video onto one or more video servers. Even if not fully described in the invention, this is very implementation dependent, this design is reflected in the proposed syntax where the media link is a URL of the RTSP type and therefore allows the client to access a recorded/stored video on demand asset (e.g., for deciding to pause a linear programmed movie and switch to a VoD session to watch in near-real-time a goal that has been scored on a match being broadcast on a different channel).

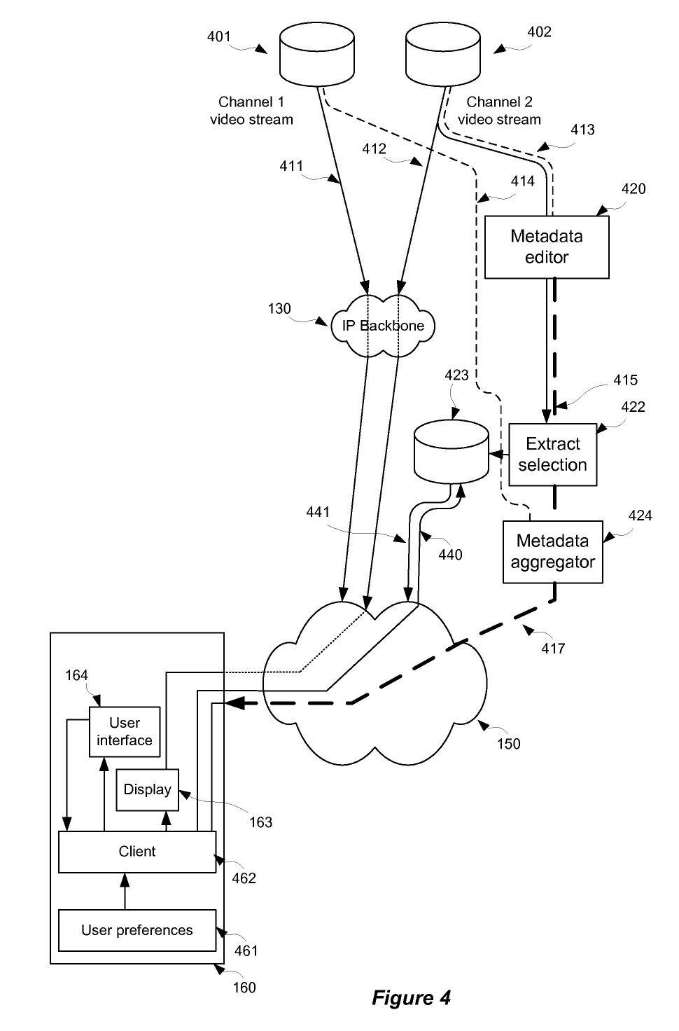

FIG. 4 shows another embodiment in accordance with the present invention. According to the embodiment of FIG. 4, there are provided data sources 401 and 402, content streams 411, 412, IP backbone 130, IP network 150, user device 160, display 163, and user interface 164. The system of FIG. 4 further comprises basic metadata 413, 414, metadata editor 420, enhanced metadata 415, 416 and metadata aggregator 424. Furthermore the user device 160 is provided with user preferences 461. All of these elements behave in a substantially equivalent manner to that described with respect to the preceding figures. There are additionally provided an extract selector 422 and an extract database 423. The extract selector 422 receives the content stream 412, and the corresponding enhanced metadata stream 414. The extract selector 422 uses the information in the enhanced metadata stream 414 to select parts of the content stream 412 for recording in the extract database 423. The extract selector 422 may be configured to select content of high general interest and short duration such as sporting or news highlights. The extract selector 422 may further modify the metadata stream 414 with further annotations indicating that certain parts of the content stream are cached in the extract database. The enhanced and annotated metadata stream is then passed on to the metadata aggregator 424, and thereafter to the user device 160 as discussed above.

On arrival at the user device 160 the aggregated metadata stream will be decoded as necessary, and compared to the user preferences 461 stored at that user device 160. It will be determined whether or not the aggregated metadata indicates that one of the content streams includes content which is of interest to the user. The system can disregard metadata concerning a content stream that the user is already accessing, since the user is presumably already aware of it's content.

In a case where it is determined that the aggregated metadata does indicate that one of the content streams includes content which is of interest to the user, assuming that the user is not already accessing the content stream in question, the system notifies the user of the content of interest. The system may then behave in any of the manners described with respect to FIG. 2. In a case where the content of interest corresponds to a part of a content stream that has been cached in the extract database 423, for example, with reference to annotations added to the metadata stream 416 by the extract selector 422, the user may be offered an alternative of viewing the event in question from the beginning, by retrieving the recording from the extract database 423. Alternatively, the system may automatically playback the event from the beginning by retrieving the recording from the extract database. As shown in FIG. 4, the user device 160 generates a request 440 to the extract database 423 for the extract in question, and in return receives a new content stream 441 from the extract database 423 for display to the user.

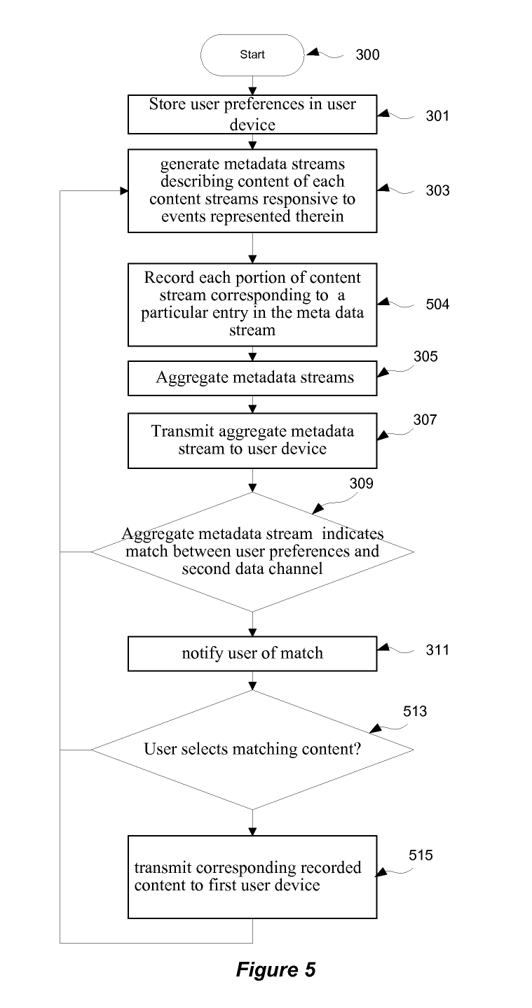

FIG. 5 shows the embodiment of FIG. 4 in the form of a flow chart. The flow chart of FIG. 5 comprises storing at a first user device content preferences of the user (301); generating respective metadata streams describing the instantaneous content of the content streams responsive to events represented in the content streams at step and associating each the content stream with the respective metadata stream (303); aggregating the metadata associated with the first and second content streams to form an aggregate metadata stream (305); transmitting the aggregate metadata stream to the first user device (307); comparing the content of the aggregate metadata stream to the preferences (309); and in a case where the content of the aggregate metadata stream is found to indicate that the content of the second content stream corresponds an aspect of the content preferences, notifying the viewer as described above with regard to the embodiment of FIGS. 2 and 3. FIG. 5 further comprises recording certain portions of the second content stream corresponding to particular entries in the metadata stream (504) between (303) and (305); offering the user an option of accessing the identified matching content (513), and transmitting the corresponding content (515) as recorded at (504) to the first user device. The skilled person will readily modify this method to implement any of the other aspects of the second embodiment as described above, or other variations as described herein.

According to yet another embodiment, the user device may request specified data from the originating data source 102, for example, in a video on demand (VoD) mode, corresponding to an event of particular interest, for example, where an event is not recorded in the extract database 423, or where the extract selection and extract database functions are not implement.

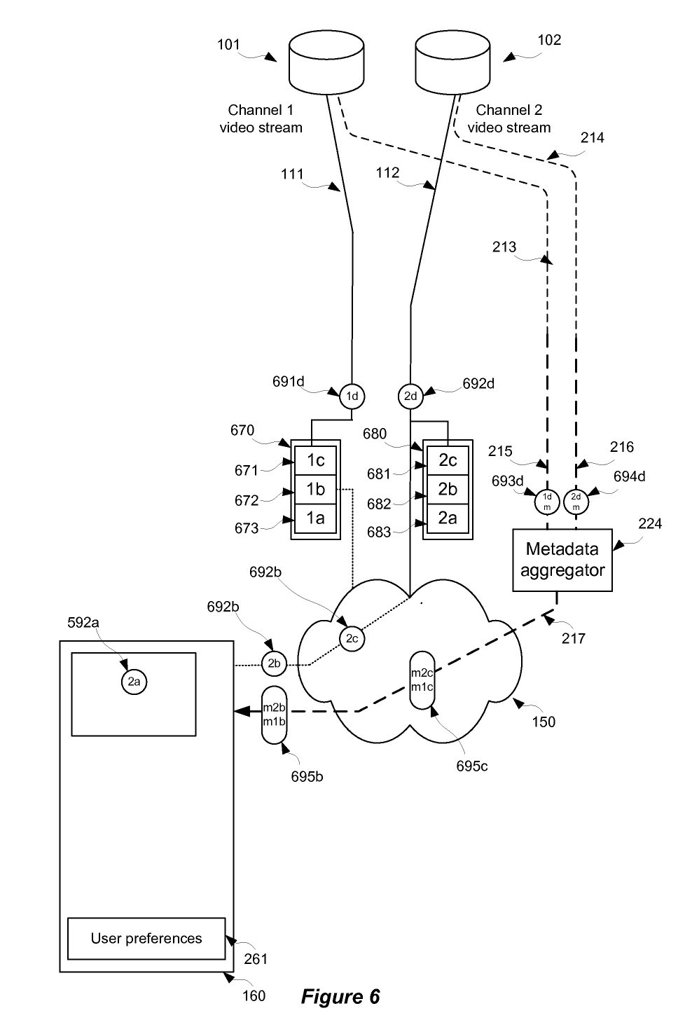

FIG. 6 illustrates a further embodiment in accordance with the present invention. As shown in FIG. 6, each content stream 111, 112 is associated with a respective buffer 670, 680 at a point in the transmission channel prior to the IP network 150. Each buffer 670, 680 comprises three slots 671, 672, 673 and 681, 682 and 683 respectively. This configuration is adopted for the same of simplicity of explanation, and the skilled person will appreciate that a real implementation of such an approach will likely be substantially more intricate. The data in the content streams 111 and 112 may be explained in terms of notional data units 691d-e in the first content stream 111 and 692d-e in the second content stream, which might correspond for example to packets, frames, pictures, etc. The alphabetical order of the reference suffix corresponds to the chronological order in which the data units are transmitted, and where appropriate, decoded. Similarly, each data unit 691n, 692n is associated with corresponding respective metadata 693n, 694n, derived as described above. The metadata aggregator 224 aggregates respective synchronous units of metadata 693n, 694n to form aggregated data units 695n. As shown, the user is presently reviewing content from the second data channel 112, and has most recently received the data unit 592a. The next data unit to be received will be 692b, which will be accompanied by aggregated metadata unit 695b, containing metadata concerning both the second content stream 112, and the first content stream 111. The buffers 670 and 680 can store content corresponding to a playback period greater than or equal to the time taken for content to propagate through the IP network 150. In a case where comparison of user preferences 261 with the contents of the aggregated metadata unit 695b indicates that the content of the first content stream data unit 691b is of interest, a request will be submitted for a new data stream to be initiated from the first content streams buffer 670 starting from data unit 691b. A new content stream will then be initiated drawing data from cell 672 of the buffer 670 for transmission to the user device 160. By means of this approach, the user does not miss any of the content of interest. Extra buffer time can be provided to allow for other delays such as user response time, user device processing time and request transmission time.

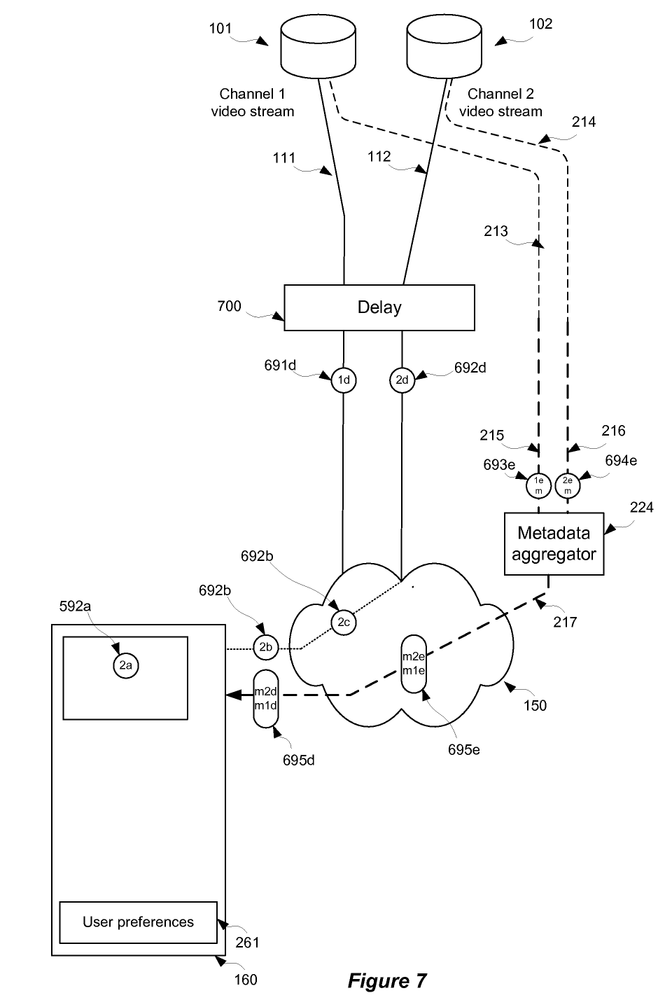

FIG. 7 illustrates another embodiment of the present invention. In this embodiment, the system will not only consider whether the aggregated metadata corresponding to the present moment in time, or presently available for reception includes content which is of interest to the user, but still further may “look ahead” to determine whether aggregated metadata concerning future content is of interest to the user. Where this last approach is adopted, a delay is introduced to the transmission of all content channel units by delay module 700. As shown in FIG. 7, the delay module 700 introduces a delay corresponding to the time taken for two data units to be processed at the user device 160. The actual amount of delay can be chosen as a function of the time a user may reasonably be expected to take to opt for the review of a new content channel, and for the request to traverse the IP network 150. No such delay is introduced to the transmission of the aggregated metadata, so that as shown in FIG. 7, the data unit 692b reaches the user device 160 at the same time as the aggregated metadata unit 695d, which contains metadata concerning data units 691d and 692d. When the user device determines that content from another channel is to be accessed, either in response to a user interaction or otherwise, the user will have time to select the new channel without missing any of the event in question.

The skilled person will appreciate that any of the techniques for ensuring that a user is able to retrieve content of interest in its entirety, for example, as described with regard to FIG. 4, 5, 6 or 7, may be used together in any combination.

Embodiments, for example, as described above, may be implemented based on a client and a server. In the context of the preceding description, the server may be considered as integrating some or all of the features of the metadata editor 420, the extract selector 422, the extract database 423, the metadata aggregator 424, and the buffers 670 and 680. The client 426 can be a software function executed on the user device 160, accessing the user preference 461, the display 163, the user interface 164, and any other means necessary. As described herein, the server features may be seen as gathering in one place key events about the programs being broadcast and preferably multicasting them for example in an XML format to a number of clients. Both client and server agree on the format that classifies events according to their categories and type.

According to certain embodiments, the server gathers two main types of events. There are events coming directly from the linear programming video sources (e.g., the TV channels being broadcast) where metadata coming with the video programs flows are used to create events in the XML file (for example, one can announce in the XML file broadcast to all clients that a program with extreme skiing is starting on channel xyz).

According to certain embodiments, the client has two main roles. On the one hand, it provides an end user Interface to allow the consumer to set the events he is interested in (e.g., <<breaking news >> on channel XYZ). On the other hand, it compares in real time the incoming flow received on the IP multicast address that carries the incoming XML events and decides based on comparison whether the current consumer linear programming (or VoD) experience should be enriched with information happening on a different channel.

An XML based syntax suitable for representation of metadata according to certain embodiments follows, by way of example:

<media-news>
<media:item>
<title UID=“123455”>Goal Juv 1/0 Real on Channel 1</title>
<media:category>sport/football/Italian Championship/goal</media:category>
<media:content assetID=“123455.mpg” SDres=“rtsp://www.foo.com/events/”
ires=“rtsp://www.foo.com/events/h i” type=“video/mpeg”/>
<media:link title=“Live Match” url=“igmp://224.1.1.1”
src=http://www.foo.com/channel1.xml U ID=“54234”>
<media:link title=“Zidane Interview” date=“xxx” url=“rtsp://www.foo.com/zizine.mpg”
src=“ ” UID=“7643”>
<media:link title=“Coup de Boule” date=“xxx” url=“rtsp://www.foo.com/boule.mp3” src=“ ”

### UID=“766643” type=audio/video/>

</media:item>
</media-news>

User preferences 261 settings can be stored at the client device level and may be replicated at the middleware level to support multi-device access. A multicast channel may be used to broadcast the metadata describing such “Media Breaking news items”. The XML file can be compressed, but still parseable, for example, in BinXML format.

According to a further embodiment, the system may be adapted to implement alternative steps to simply notifying the user of a match between his preferences and a content stream. The system may automatically prevent playback of content classified by its associated metadata in a particular way, for example, as pertaining to violent or sexual subject matter, or being intrusively loud, etc. Access permissions may be defined so that certain users, e.g., “child users” may define preferred subject matter and or excluded subject matter, but may or may not be able to edit excluded subject matter setting defined by certain other classes of users, e.g., “parent users”. Indeed, this content exclusion approach would allow the system to be set up simply to select an alternative content stream when excluded subject matter such as promotional material was transmitted, or when unpleasant issues are addressed in a news broadcast, for example. Still further, preferences may define “required” settings, whereby regardless of a user's wishes, he may be obliged to review certain content. This approach may be appropriate for example where it is a condition that for access to certain content a user is obliged to review a certain amount of promotional material.

It will be appreciated that the functions of the user device may be distributed amongst a number of discrete devices. For example, it may be desirable to use an existing display device such as a television set, while integrating the other features in a set top box. It may be appropriate to enable further devices to relay notification information to the user, even where those further devices themselves are not capable of displaying the content to the user. According to an embodiment, the user device 160 is a mobile device, capable of receiving IP data via a wireless connection, such as a mobile telephone, laptop computer, or PDA.

According to a further embodiment, metadata and data may be transmitted over separate channels. Content data and metadata may each be transmitted over any suitable channel, such as the internet, a private network such as a LAN, WAN, MAN, etc., over a satellite, cable, or telephone connection, whether digital or analog, in a data mode or a voice mode, over a radio link such as a WiFi, Bluetooth, cellular telephone network, etc. Any combination of two such channels may be envisaged for respective transmission of content and metadata. Still further, different content streams described by the same aggregated metadata may be transmitted over different channels, or in different formats. For example, the same aggregated metadata may be used to describe television data arriving both via a conventional hertzian connection, and via a satellite, cable or internet connection.

The skilled person will appreciate that while the present invention is described in the context of television channels, the invention may be applied equally to any medium through which multiple channels are transmitted from which a user may wish to select. For example, radio or text services such a syndication or teletext service.

According to still further embodiments, a content stream user can define preferences, which are compared to aggregated metadata describing in real time a plurality of content streams to which the user has access. The meta data for each content stream may be generated by automated analysis of onscreen indicators, noise levels in standard video or audio sequences, or speech recognition or image recognition data applied to identify particular keywords, individuals, etc. Where a match between content and user preferences is identified, the user is notified, and may be given the option of switching to the matching content stream. A number of approaches to ensuring that the user is able to access the whole of the content of interest, and especially does not miss the start of porting, can be used. For example, certain parts of the content streams may be cached for video on demand viewing, or the content streams may be buffered allowing access to various portions of the stream, or a delay in content transmission may be introduced relative to the metadata transmission so as to allow time for a content stream change.

The invention can take the form of an entirely hardware embodiment, an entirely software embodiment or an embodiment containing both hardware and software elements. In an embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method of informing a user of a first content stream at a first user device of content of a second content stream that may be of interest to the user, comprising:
storing content preferences of the user at the first user device;
receiving an aggregate metadata stream at the first user device, the aggregate metadata stream comprising data aggregated from a plurality of metadata streams describing respectively an instantaneous content of the content streams responsive to events represented in the content streams;
comparing a content of the aggregate metadata stream to the content preferences of the user; and
in a case where the content of the aggregate metadata stream is found to indicate that the content of the second content stream corresponds to an aspect of the content preferences of the user, notifying the user.

2. The method of claim 1, wherein notifying the user further comprises:
offering the user an option of using the second content stream in place of the first content stream, and in a case where the user accepts the offer, proceeding to transmit the second content stream to the first user device.

3. The method of claim 1, wherein each content stream comprises video data.

4. The method of claim 1, wherein the first user device is a mobile terminal, and the content streams are transmitted over an IP network.

5. A method of informing a user of a first content stream at a first user device of content of a second content stream that may be of interest to the user, comprising:
generating respective metadata streams describing an instantaneous content of the content streams responsive to events represented in the content streams;
associating each content stream with the respective metadata stream;
aggregating the metadata associated with the first and second content streams to form an aggregate metadata stream;
transmitting the aggregate metadata stream to the first user device for comparison of a content of the aggregate metadata stream to user content preferences stored at the first user device; and
notifying the user in a case where the content of the aggregate metadata stream is found to indicate that the content of the second content stream corresponds to an aspect of the content preferences.

6. The method of claim 5, wherein generating the respective metadata streams describing the instantaneous content of the content streams further comprises:
automatically analyzing onscreen indicators, noise levels in standard video or audio sequences, or speech recognition or image recognition data to identify particular keywords, individuals, or other data.

7. The method of claim 5, wherein notifying the user further comprises:
offering the user an option of using the second content stream in place of the first content stream, and in a case where the user accepts the offer, proceeding to transmit the second content stream to the first user device.

8. The method of claim 7, further comprising:
recording parts of the second content stream corresponding to particular entries in the metadata stream indicating the content thereof, and
in a case where the user accepts the offer, transmitting the recorded content to the first user device.

9. The method of claim 7, further comprising:
buffering data units of the second content stream in a buffer, and, in a case where the user accepts the offer, transmitting a playback request specifying a particular point in the second content stream from the first user device, and transmitting the second data stream by reading out the content from a particular position in the buffer.

10. The method of claim 7, further comprising:
introducing a time offset to a transmission of the second content stream with respect to a transmission of the corresponding metadata so that corresponding metadata comprised in the aggregate metadata stream arrives at the user device in advance of the corresponding content, so that when transmitting the second content stream to the first user device, the user receives the content corresponding to an aspect of the content preferences.

11. The method of claim 5, wherein each content stream comprises video data.

12. The method of claim 5, wherein the first user device is a mobile terminal, and the content streams are transmitted over an IP network.

13. A program product stored on a computer readable medium, which when executed, informs a user of a first content stream at a first user device of content of a second content stream that may be of interest to the user, the computer readable medium comprising program code for:
storing content preferences of the user at the first user device;
receiving an aggregate metadata stream at the first user device, the aggregate metadata stream comprising data aggregated from a plurality of metadata streams describing respectively an instantaneous content of the content streams responsive to events represented in the content streams;
comparing a content of the aggregate metadata stream to the content preferences of the user; and
in a case where the content of the aggregate metadata stream is found to indicate that the content of the second content stream corresponds to an aspect of the content preferences of the user, notifying the user.

14. A system for informing a user of a first content stream at a first user device of content of a second content stream that may be of interest to the user, comprising:
a system for storing preferences of the user at the first user device content;
a system for receiving an aggregate metadata stream at the first user device, the aggregate metadata stream comprising data aggregated from a plurality of metadata streams describing respectively an instantaneous content of the content streams responsive to events represented in the content streams;
a system for comparing a content of the aggregate metadata stream to the content preferences of the user; and
a system for notifying the user in a case where the content of the aggregate metadata stream is found to indicate that the content of the second content stream corresponds to an aspect of the content preferences of the user.
